(19) United States
(12) Patent Application Publication
(10) Pub. No.: US 2007/0050420 A1
(43) Pub. Date: Mar. 1, 2007

(54) Method and apparatus for transferring data between databases

(76) Inventor: Anand D. Sankruthi, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,425

(22) Filed: Jul. 26, 2006

(30) Foreign Application Priority Data
Aug. 30, 2005 (IN) IN1211/CHE/2005

(51) Int. Cl. G06F 17/30

(52) U.S. Cl. 707/200

(57) ABSTRACT

A method and apparatus is disclosed for transferring data between database in which a relationship governing the transfer is defined in a configuration file.

### BACKGROUND OF THE INVENTION

The structure of a database system is called a schema and is described in a formal language supported by the database management system (DBMS). The database schema defines the organization of the data in the database in terms of tables of fields. Fields contain the actual data and are arranged across the rows of a table.

Transferring data between databases provides a number of challenges. Any given databases may have different schema, that is, they may hold their data organized in a different manner. Also, the data sets held by different databases may differ. Furthermore, the databases may be provided by different database application programs which are not compatible or cannot communicate with other such programs.

One method of transferring data between databases involves exporting data in a special format from a source database into a special data structure. The data structure can then be detached from the source database and the contents of the data structure serially loaded into a destination database. Some database programs have a facility for exporting their data into a file in XML (eXtendable Mark-up Language). The XML file can then be uploaded to another database.

However, one problem with the above methods is that they are designed for databases with the same schema. In other words, they are designed to transfer the same database from one platform or database application program to another.

Another method for transferring data between databases is to write a bespoke transfer program to transfer data between specific source and destination schemas. However, such programs are expensive to produce and specific to the databases for which they were created. Furthermore, if the schema of any of the source or destination databases are changed, the transfer program will require expensive and time consuming modification.

### BRIEF DESCRIPTION OF THE DRAWINGS

Embodiments of the invention will now be described, by way of example only, with reference to the accompanying drawings in which:

FIG. 1 illustrates a schematic illustration of a computer system comprising two databases;

FIG. 2 illustrates a set of tables illustrating tables in the schemas of the databases of FIG. 1;

FIG. 3 illustrates the contents of a configuration file which defines a relationship between the schemas of FIG. 2;

FIG. 4 illustrates a flow chart illustrating processing carried out to transfer data between the schemas of FIG. 2; and

FIGS. 5a, 5b, 5c & 5d illustrates a worked example of data being transferred between the schemas of FIG. 2.

### DETAILED DESCRIPTION OF EMBODIMENTS OF THE INVENTION

An embodiment of the technique disclosed provides a method for transferring data from a source database having a source schema to a destination database having a destination schema each schema comprising one or more fields for data, the method comprising the steps of:

a) creating a configuration file determining a relationship between the source schema and the destination schema;

b) defining in the configuration file, one or more fields in the source schema from which data is to be transferred to the destination database; and

c) defining in the configuration file, a field in the destination schema for receipt of the data from one or more of the identified fields in the source schema.

The method may comprise the further step of: d) transferring data from the source database to the destination database in accordance with the relationship determined by the configuration file. The transferring may be carried out by a transfer program. The transfer program may use the configuration file to create one or more database queries statements for the transferring of data. The statements may be created in SQL. The configuration file may be created in a text mark-up language. The text mark-up language may be XML.

The definition of the field in the destination schema for receipt of the data from the source schema may include a definition of the data type of the destination field. The configuration file may define one or more further relationships between further source schemas and the destination schema for enabling the transfer of data from two or more source schemas to the destination schema. The configuration file may comprise a separate entry for each of the relationships.

An entry in the configuration file may define one or more selection criteria associated with the source schema, the criteria governing the selection of data from the field for transfer to the destination field. The selection criteria may be defined by a key-value pair. The selection criteria may include an element inherited from another entry in the configuration file. The selection criteria may be dynamically determined when the data is transferred.

Each entry may define an operation governing the transfer of the data into the destination schema. The operation may be an insert operation. The operation may be a clear and insert operation. The operation may be an update operation on one or more keys. A plurality of keys may be defined, the order in which the keys are applied being defined by the order of the destination fields in the entry.

Some embodiments provide apparatus for transferring data from a source database having a source schema to a destination database having a destination schema each schema comprising one or more fields for data, the apparatus being operable to:
create a configuration file determining a relationship between the source schema and the destination schema;
define in the configuration file, one or more fields in the source schema from which data is to be transferred to the destination database; and
   define in the configuration file, a field in the destination schema for receipt of the data from one or more of the identified fields in the source schema.

Some embodiments provide a configuration file for use with a data transfer program for transferring data from a source database having a source schema to a destination database having a destination schema each schema comprising one or more fields for data, the configuration file comprising:

a) data defining a relationship between the source schema and the destination schema;

b) first mapping data identifying one or more fields in the source schema from which data is to be transferred to the destination database; and

c) second mapping data identifying a field in the destination schema for receipt of the data from one or more of the identified fields in the source schema.

Other embodiments provide a program or group of programs arranged to enable a programmable device or group of such devices to carry out a method for transferring data from a source database having a source schema to a destination database having a destination schema each schema comprising one or more fields for data, the method comprising the steps of:

a) creating a configuration file determining a relationship between the source schema and the destination schema;

b) defining in the configuration file, one or more fields in the source schema from which data is to be transferred to the destination database; and

c) defining in the configuration file, a field in the destination schema for receipt of the data from one or more of the identified fields in the source schema.

Other embodiments provide program or group of programs arranged to enable a programmable device or group of such devices to provide apparatus for transferring data from a source database having a source schema to a destination database having a destination schema each schema comprising one or more fields for data, the apparatus being operable to:

create a configuration file determining a relationship between the source schema and the destination schema;

define in the configuration file, one or more fields in the source schema from which data is to be transferred to the destination database; and

define in the configuration file, a field in the destination schema for receipt of the data from one or more of the identified fields in the source schema.

Some embodiments provide a program or group of programs arranged to enable a programmable device or group of such devices to provide apparatus for transferring data from a source database having a source schema to a destination database having a destination schema each schema comprising one or more fields for data, the apparatus comprising:

means for creating a configuration file determining a relationship between the source schema and the destination schema;

means for defining in the configuration file, one or more fields in the source schema from which data is to be transferred to the destination database;

means for defining in the configuration file, a field in the destination schema for receipt of the data from one or more of the identified fields in the source schema; and

means for transferring data in accordance with the relationship.

Other embodiments provide a program or group of programs arranged to enable a programmable device or group of such devices to provide a configuration file for use with a data transfer program for transferring data from a source database having a source schema to a destination database having a destination schema each schema comprising one or more fields for data, the configuration file comprising:

a) data defining a relationship between the source schema and the destination schema;

b) first mapping data identifying one or more fields in the source schema from which data is to be transferred to the destination database; and

c) second mapping data identifying a field in the destination schema for receipt of the data from one or more of the identified fields in the source schema.

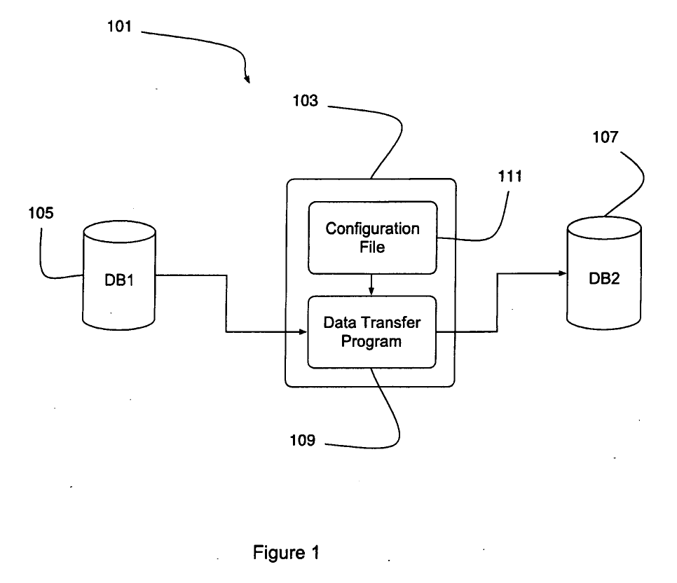

With reference to FIG. 1, a computer system 101 comprises a computer 103 connected to a first database (DB1) 105 and a second database (DB2) 107. Each database has a different database schema which will be described in further detail below. The computer 103 runs an operating system (not shown) and database application programs (not shown) for each database. The computer is operable to provide access by users to the data in the databases via the database application programs. The computer also runs a data transfer program 109 which is operable to transfer data between the databases 105, 107. The program 109 uses a configuration file 111 which defines a relationship for transferring data from a source database schema to a destination database schema.

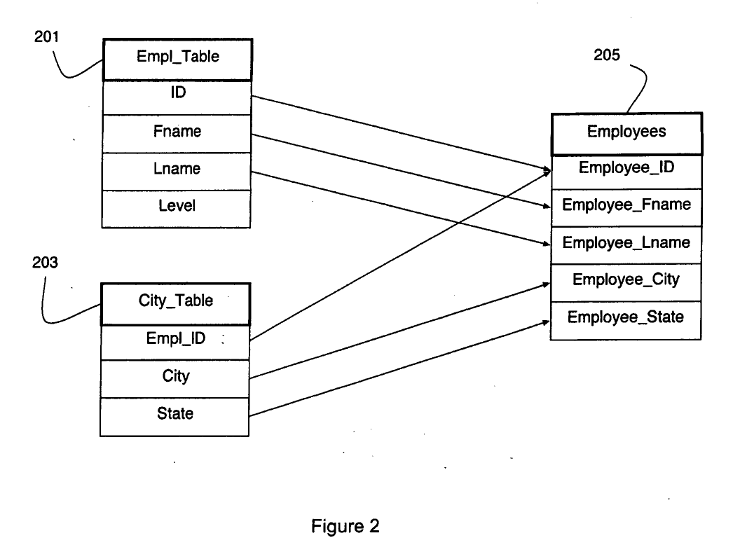

With reference to the FIG. 2, the first database 105 has a first table 201 labeled “Empl_Table” which has four fields (ID, Fname, Lname, Level) and a second table 203 labeled “City_Table” having three fields (Empl_ID, City, State). The second database 107 has a table 205 labeled “Employees” having five fields (Employee_ID, Employee_Fname, Employee_Lname, Employee_City, Employee_State). In the present embodiment the configuration file 111 defines a transfer relationship for transferring data from the first database 105 to the second database 107 between the fields as shown by the arrows in FIG. 2.

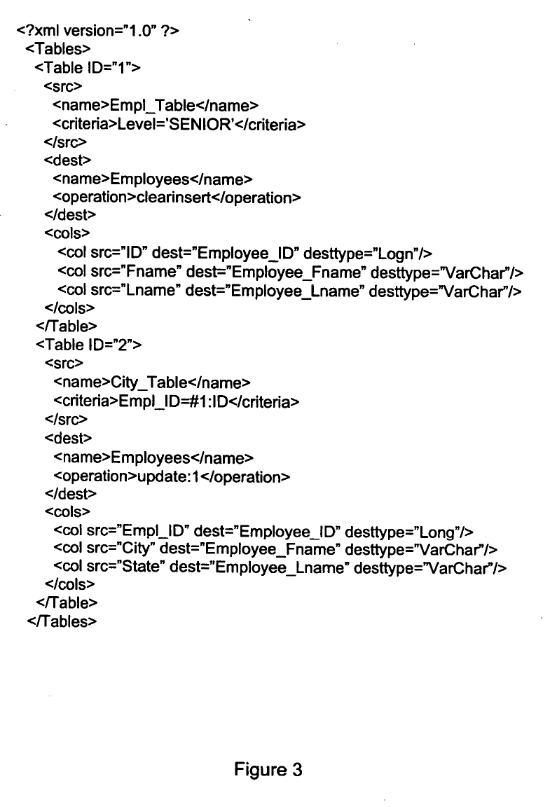

The transfer relationship in configuration file 111 is written in a text mark-up language in the form of XML as shown in FIG. 3. In the present embodiment, the configuration file is coded manually. The transfer relationship is structured so that there is a single entry for each source database table from which data is to be transferred. Each entry is allocated a unique identifier (ID) and also includes the source table name (<src>/<name>) and a destination table name (<dest>/<name>). In addition to this, each entry may optionally specify selection criteria (<src>/<criteria>) for selecting data from a source database table. The criteria may be either static or dynamic as described in further detail below. Each entry also specifies a database operation (<dest>/<operation>) to be performed when populating the destination table. The operation can be either Insert, ClearInsert or Update and these operations are described in further detail below. A mapping (<cols>) is also provided between each source table field name and the corresponding destination table field name. The data type of the field in the destination database field may also be specified.

The criteria entry noted above consists of a key-value pair and may be static or dynamic. An example of a static criterion entry is shown in FIG. 3 by Level=“Senior”, where the key is the field name Level from the first table 201 and the field value is “Senior”. A dynamic criterion entry inherits the criterion defined for another table and is resolved during the processing of the data transfer program 109. Dynamic criteria are indicated when the value starts with “#n” where n identifies another table in the configuration file. The second table entry in FIG. 3 has a dynamic criterion entry in the form Empl_ID=#1:ID. This selection criterion will be resolved during run time and inherit the run time selection criterion from the table Empl_Table (Table ID 1). The result will be a selection criterion which specifies the selection of values from the table City_Table where the Empl_ID field matches the ID field of the table Empl_Table (Table ID=1) and where the corresponding Level field has the value “Senior”.

As noted above, the operation entry can specify one of three operations (Insert, ClearInsert & Update). In an Insert operation, new rows are appended to the existing rows (if any) in the database table. In a ClearInsert operation, designated rows are cleared before selected data is inserted. In the Update operation, columns in already existing rows of the database are updated. However, in order to update existing rows, it is necessary to identify the rows to which update is applied. For this purpose, one or more of the destination table columns are designated as updation keys. For example, in the Employees table 205, the Employee_ID field is designated as the key column as it is common between the two source tables 201, 205. This way, when rows from the Empl_Table table 201 are inserted into the Employees table 205, they can then be updated from the City_Table table 205 with the City and State information only where the entries in the key fields match. In other words, the update operation provides the intersection between two sets of source data on the axis of the respective ID and Empl_ID fields.

The Update operation also specifies a number, which is the number of destination table columns to be used as keys. The keys are taken sequentially from the mapping (<cols>) entry. Therefore, the order of the mappings is important. For example, if two keys are specified then they must be the first two lines of the mappings (<cols>). In the 2nd table entry of FIG. 3, an Update:1 operation designates the “Emplyee_ID” column of the destination table as the key and accordingly “Emplyee_ID” is the first item under <cols>.

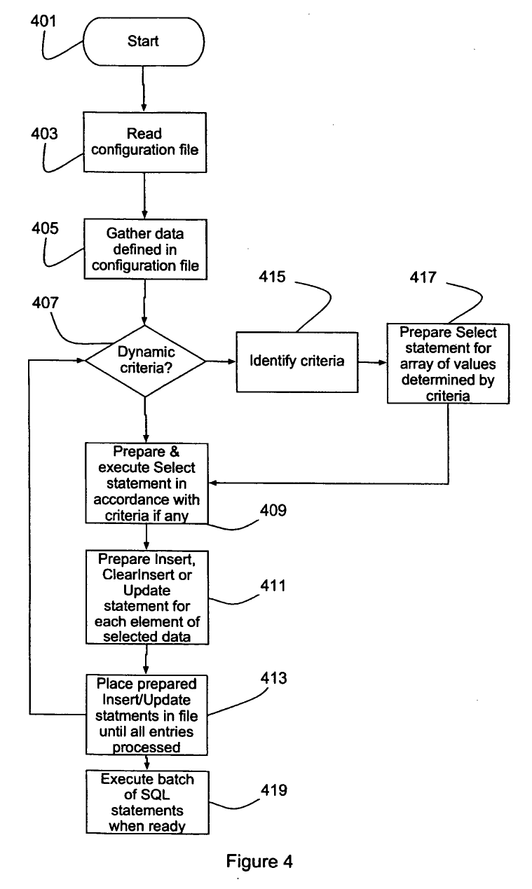

The processing carried out by the transfer program 109 to transfer data in accordance with the configuration file 111 will now be described further with reference to the flow chart of FIG. 4. At step 401, the process is initiated and processing moves to step 403 where the configuration file 111 is identified and opened. Processing then moves to step 405 where the following information is collected from the configuration file for each table entry:

SRC_NAME = <src>/<name>
SRC_CRITERIA = <src>/<criteria>
DEST_NAME = <dest>/<name>
DEST_OPERATION = <dest>/<operation>
SRC_COLS[ ] = array of all <col> src attributes
DEST_COLS[ ] = array of all <col> dest attributes
DEST_TYPES[ ] = array of all <col> desttype attributes

Thus, the following data is extracted from the XML:

For Table ID: 1

SRC_NAME: Empl_Table
SRC_CRITERIA: Level= “Senior”
DEST_NAME: Employees
DEST_OPERATION: ClearInsert
SRC_COLS[ ]: ID, Fname, Lname
DEST_COLS[ ]: Employee_ID, Employee_Fname, Employee_Lname
DEST_TYPES[ ] = Long, VarChar, VarChar

For Table ID: 2

SRC_NAME: City_Table
SRC_CRITERIA: Empl_ID=#1:ID
DEST_NAME: Employees
DEST_OPERATION: Update:1
SRC_COLS[ ]: Empl_ID, City, State
DEST_COLS[ ]: Employee_ID, Employee_City, Employee_State
DEST_TYPES[ ] = Long, VarChar, VarChar

Processing then moves to step 407 where, for each set of table data in turn, the criterion (SRC_CRITERIA) is inspected to determine if the criterion is dynamic. This is indicated by the value of the key-value pair starting with a hash symbol (#). Thus, for Table ID:1, the criterion is static and stored in a variable called CRITERIA as ‘Level=“Senior”’. Processing then moves to step 409 where an SQL Select statement is created and executed to extract data from the table 201 in accordance with the resolved criterion into an array called SRC_VALUES. The SQL Select statement produced and executed is as follows:

SRC_VALUES[ ] = Select ID, Fname, Lname from
Empl_Table where Level=
“Senior”

Processing then moves to step 411 where the type of operation determined by the DEST_OPERATION data is identified. In the case of Table:ID1, the operation is a ClearInsert operation, so the contents of the table Employees are cleared and the following SQL Insert statement is produced to insert each elements from the SRC_VALUES array into the appropriate destination fields:
Insert into Employees (Employee_ID, Employee_Fname, Employee_Lname) values (SRC_VALUES[i]_ID, SRC_VALUES[i]_FNAME, SRC_VALUES[i]_LNAME)—where i=0 to SizeOf(SRC_VALUES[ ])

Processing then moves to step 413 where the above Insert statement is placed into a file for later batch execution.

Processing then returns to step 407 to determine if the criterion for the next table of values is dynamic. Table ID:2 is identified as having a dynamic criterion (Empl_ID=#1:ID) and processing moves to step 415. At step 415, the source of the dynamic criterion is decoded, “#1” indicating that the table in the configuration file with an ID of 1 is the source of the second key-value pair that provides the selection criterion. In other words, the criterion indicates that values must be taken from the “ID” column of the table Empl_Table 201 where the values of ID and Empl_ID match. Furthermore, the criteria for Table:ID1 are inherited via the CRITERIA variable currently set to “Level=“SENIOR””. Processing then moves to step 417 where SQL statements are produced and executed to select the values determined by the resolved selection criteria into an array called VALUES. The SQL select statement is as follows:

VALUES[ ] = Select ID from Empl_Table where
Level=“Senior”
NEW_CRITERIA = “Empl_ID=VALUES[0] or
Empl_ID=VALUES[1] or
Empl_ID=VALUES[2] or ...
Empl_ID=VALUES[i]”
- where i is the size of VALUES[ ]
CRITERIA=NEW_CRITERIA

Processing then moves to step 409 where a Select statement is prepared and executed to select the data from the table City_Table 203 in accordance with the new resolved and inherited criteria defined in the updated CRITERIA array, that is, where the Empl_ID entry has the same value as the ID entry of the table Empl_Table 201 and where that ID entry has a Level entry with the value “Senior”. The Select statement is as follows:
SRC_VALUES[ ]=Select Empl_ID, City, State from City_Table where Empl_ID=CRITERIA[0] or Empl_ID=CRITERIA[1] or Empl_ID=CRITERIA[2] or . . . . Empl_ID=CRITERIA[i]

Processing then moves to step 411 as described above where the operation is identified as an Update operation with one key (Update:1), that is, with Employee_ID as the key. The resulting SQL Update statement is as follows:

Update into Employees where (Employee_ID =
SRC_VALUES[i]_Empl_ID)
set (Employee_City = SRC_VALUES[i]_CITY,
Employee_State =
SRC_VALUES[i]_STATE) - where i = 0 to
SizeOf(SRC_VALUES[ ])

Processing then moves to step 413 where the generated SQL statements are added to the file for batch execution. Since each entry of the configuration file has now been processed, processing moves to step 419 where the file of collected SQL Insert and Update statements are executed as a batch to insert and update the appropriate data in the destination table 205.

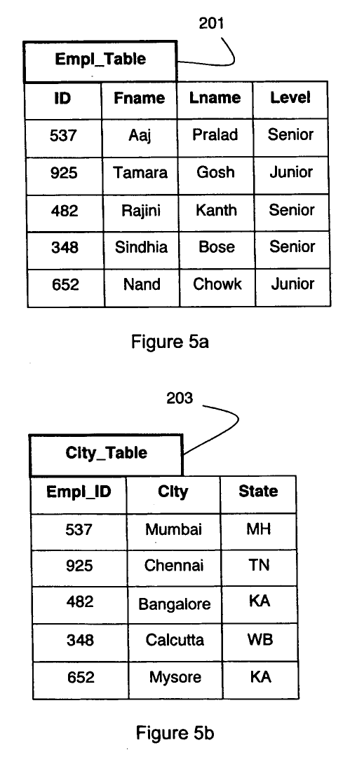

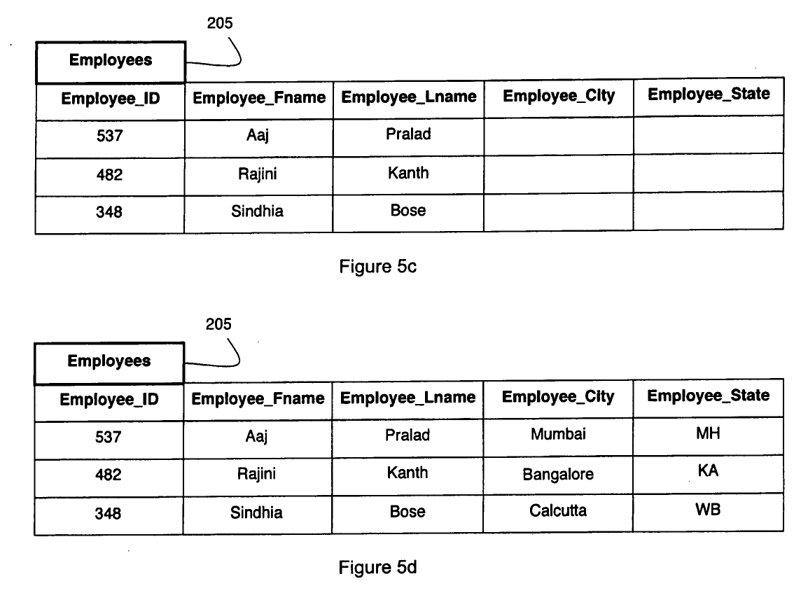

FIGS. 5a, b, c & d illustrate the effect of the SQL statements generated as described above and applied in step 419. FIGS. 5a and 5b illustrate the table Empl_Table 201 and the City_Table 203 each populated with five rows of data relating to the employees of a company. The requirement, set out in the configuration file 111, is to create a new table 205 from these tables 201, 203 which includes the employee identification number (ID), first and last names (Fname & Lname), city and state of employment (City, State) of all employees whose Level is “Senior”. As noted above the first table entry in configuration file results in the following Select statement:

Select ID, Fname, Lname from Empl_Table where Level=“Senior”

The result of this statement on the table Employees 205 is shown in FIG. 5c where only the employees with a Level of “Senior” appear. The second entry in the configuration file is used to fill in the remaining portion of the table Employees 205, which are the City and State columns. The selection criterion for the select rows from the City_Table 203 require that the Empl_ID field is the same as one of the ID fields from the table Empl_Table 201 which has the effect of picking out employee identification numbers 537, 482 and 348. The data transfer program also ensures that the criteria for the selection for the first table is inherited (Level=“Senior”). Thus, the select statement generated from the second entry in the configuration table is:

Select Empl_ID, City, State from City_Table where Empl_ID=537 or
Empl_ID=482 or Empl_ID=348

The resultant data is updated into the table Employees 205 table as shown in FIG. 5d. Note that the table is updated in accordance with the “update:1” operation, where the “1” indicates that the first item in the <col>/<src>, that is Empl_ID, is used as the updation key.

As will be understood by those skilled in the art, the data transfer program can be arranged to produce equivalent statements in any suitable database query language. Also the configuration file may be written in any other suitable mark-up language.

In another embodiment, the configuration file is created automatically using a configuration file creation (CFC) program. The CFC program is arranged to prompt a user to identify source and destination databases. The CFC program then identifies and inputs the schemas of the identified databases and displays them to the user via a graphical user interface (GUI). The user is then able to select the tables which will be the source and destination of the data to be transferred and to define selection criteria (if any) and keys relevant to the transfer. In response to the completed user input, the CFC program then produces a configuration file in XML which can be used by the data transfer program to carry out the requested data transfer. The CFC may incorporate an XML editor such as XMLSpy™ produced by Altova™ GmbH, Austria.

In a further embodiment, the configuration file does not contain any criteria entry thus omitting the facility for filtering the data to be transferred. Omitting this feature enables data to be transferred more simply between databases without being pre-filtered.

In another embodiment, data is transferred between one source table and one destination table. In another embodiment, data is transferred between one or more source tables and a one or more of destination tables. The source or destination tables may be from the same or different databases. In a further embodiment, data is transferred from two or more source databases to a destination database, each source database having a separate configuration file.

It will be understood by those skilled in the art that the apparatus that embodies a part or all of the technique disclosed above may be a general purpose device having software arranged to provide a part or all of an embodiment of the disclosure. The device could be single device or a group of devices and the software could be a single program or a set of programs. Furthermore, any or all of the software used to implement the technique disclosed can be communicated via various transmission or storage means so that the software can be loaded onto one or more devices.

While the present technique has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the technique disclosed here, in its broader aspects is not limited to the specific details representative apparatus and method, and illustrative examples shown and described. Accordingly, departures may be made from such details without departure from the spirit or scope of applicant's general inventive concept.

1. A method for transferring data from a source database having a source schema to a destination database having a destination schema each said schema comprising one or more fields for data, the method comprising the steps of:
a) creating a configuration file determining a relationship between said source schema and said destination schema;
b) defining in said configuration file, one or more fields in said source schema from which data is to be transferred to said destination database; and
c) defining in said configuration file, a field in said destination schema for receipt of said data from one or more of said identified fields in said source schema.

2. A method according to claim 1 comprising the further steps of:
d) transferring data from said source database to said destination database in accordance with said relationship determined by said configuration file.

3. A method according to claim 2 in which said transferring is carried out by a transfer program.

4. A method according to claim 3 in which said transfer program uses said configuration file to create one or more database queries statements for said transferring of data.

5. A method according to claim 1 in which said configuration file is created in a text mark-up language.

6. A method according to claim 1 in which said definition of said field in said destination schema for receipt of said data from said source schema includes a definition of the data type of said destination field.

7. A method according to claim 1 in which said configuration file defines one or more further relationships between two or more further source schemas and said destination schema for enabling the transfer of data from said two source schemas to said destination schema.

8. A method according to claim 7 in which said configuration file comprises a separate entry for each said relationship.

9. A method according to claim 1 in which an entry in said configuration file defines one or more selection criterion associated with said source schema, said criterion governing the selection of data from said field for transfer to said destination field.

10. A method according to claim 9 in which each said selection criteria is defined by a key-value pair.

11. A method according to claim 10 in which one or more of said selection criterion include an inherited element.

12. A method according to claim 10 in which one or more of said selection criterion are dynamically determined when said data is transferred.

13. A method according to claim 12, in which each said entry defines an operation governing the transfer of said data into said destination schema.

14. Apparatus for transferring data from a source database having a source schema to a destination database having a destination schema each said schema comprising one or more fields for data, the apparatus being operable to:
create a configuration file determining a relationship between said source schema and said destination schema;
define in said configuration file, one or more fields in said source schema from which data is to be transferred to said destination database; and
define in said configuration file, a field in said destination schema for receipt of said data from one or more of said identified fields in said source schema.

15. Apparatus according to claim 14 being further operable to:
transfer data from said source database to said destination database in accordance with said relationship determined by said configuration file.

16. Apparatus according to claim 14 in which said definition of said field in said destination schema for receipt of said data from said source schema includes a definition of the data type of said destination field.

17. Apparatus according to claim 14 in which said configuration file defines one or more further relationships between two or more further source schemas and said destination schema for enabling the transfer of data from said two source schemas to said destination schema.

18. Apparatus according to claim 14 in which an entry in said configuration file defines one or more selection criterion associated with said source schema, said criterion governing the selection of data from said field for transfer to said destination field.

19. Apparatus according to claim 14 in which each said entry defines an operation governing the transfer of said data into said destination schema.

20. A configuration file for use with a data transfer program for transferring data from a source database having a source schema to a destination database having a destination schema each said schema comprising one or more fields for data, the configuration file comprising:
a) data defining a relationship between said source schema and said destination schema;
b) first mapping data identifying one or more fields in said source schema from which data is to be transferred to said destination database; and
c) second mapping data identifying a field in said destination schema for receipt of said data from one or more of said identified fields in said source schema.
